(19) United States
(12) Patent Application Publication
(10) Pub. No.: US 2021/0108929 A1
(43) Pub. Date: Apr. 15, 2021

(54) DYNAMIC SELECTION OF AUTONOMOUS VEHICLE STOPPING POINTS

(71) Applicants: Yi Zhang, Portland, OR (US); Frederik Pasch, Karlsruhe (DE); Hao Feng, Hillsboro, OR (US); Cornelius Buerkle, Karlsruhe (DE); Maruti Gupta Hyde, Portland, OR (US); Fabian Oboril, Karlsruhe (DE); Ravikumar Balakrishnan, Beaverton, OR (US); Kay-Ulrich Scholl, Malsch (DE)

(72) Inventors: Yi Zhang, Portland, OR (US); Frederik Pasch, Karlsruhe (DE); Hao Feng, Hillsboro, OR (US); Cornelius Buerkle, Karlsruhe (DE); Maruti Gupta Hyde, Portland, OR (US); Fabian Oboril, Karlsruhe (DE); Ravikumar Balakrishnan, Beaverton, OR (US); Kay-Ulrich Scholl, Malsch (DE)

(21) Appl. No.: 17/131,625

(22) Filed: Dec. 22, 2020

(51) Int. Cl. G01C 21/34; G01C 21/36; G06N 20/00

(52) U.S. Cl. CPC G01C 21/3415; G01C 21/3423; G06N 20/00; G01C 21/3617; G01C 21/3691; G01C 21/3461

(57) ABSTRACT

Disclosed are embodiments for adjusting a vehicle stopping point. The vehicle stopping point is a point between a route of the vehicle and a second route. in some embodiments, an adjustment to the stopping point is determined based on ranking secondary routes that are adjusted based on the adjusted vehicle stopping point. Tanking of the secondary routes is based, in sonic embodiments, on a score of segment(s) included in the secondary routes. In some cases, the ranking of the segments considers safety information associated with each of the segments.

### BACKGROUND

Autonomous vehicles (AVs) promise transportation services that will provide significant improvements in efficiency and convenience. Selecting an appropriate stopping point (e.g. pick-up, drop-off, or transportation mode change points) (e.g. in a multi-modal trip) can have a large impact on overall rider satisfaction. Thus, improved methods of selecting these stopping locations are desired.

### BRIEF DESCRIPTION OF THE DRAWINGS

The present disclosure is illustrated by way of example and not limitation in the figures of the accompanying drawings, in which like references indicate similar elements and in which:

FIG. 1 is an overview diagram showing one embodiment of improving a user experience.

FIG. 2 is another overview diagram illustrating selection of a pick-up or drop off location for delivery of an autonomous vehicle based transportation service.

FIG. 3 shows example data structures implemented in one or more of the disclosed embodiments.

FIG. 4 is a block diagram of one embodiment of a mobility service.

FIG. 5 shows an example machine learning module implemented by one or more of the disclosed embodiments.

FIG. 6 shows a data flow of a model in one or more of the disclosed embodiments.

FIG. 7 is a flowchart of a method for determining a pick-up or drop off location of a passenger.

FIG. 8 illustrates a block diagram of an example machine upon which any one or more of the techniques (e.g., methodologies) discussed herein may perform.

### DETAILED DESCRIPTION

The present disclosure recognizes that modern ride sharing services generally provide little choice to users when selecting a pickup or drop off location. Instead, with respect to pick-up locations, ride sharing services generally require the user to wait for their ride at a location selected by the ride sharing application, which typically defaults to the user's current position. In some cases, the user is able to input an address to use as a pickup location.

Under some environmental conditions, such as in a crowded urban area, a one-way street, a campus environment, an environment, that includes traffic control, or in the case of a recent traffic incident or accident, the vehicle stopping point automatically selected by the ride-sharing application is or becomes inappropriate. In some cases, changing events make an initially acceptable vehicle stopping point (e.g. pick-up location) unacceptable. A typical method of resolving this problem requires the driver or the passenger (whoever might recognize the problem first), to initiate contact with the other (e.g. via a messaging application provided by the ride sharing application, or view traditionally phone or text messaging services outside the ride sharing application). However, this manual process for selecting a new vehicle stopping point (e.g. pick-up location) lacks convenience and can be inferior in several respects. For example, in some cases, neither the driver nor the passenger are particularly familiar with the details regarding the general area, and thus selecting a new stopping point, especially under time pressure and while the driver is focused on navigating the vehicle, can be challenging. Furthermore, if an autonomous vehicle is providing the ride service, there is no human driver to contact. Thus, an ability of a passenger to quickly and easily modify the vehicle stopping point (e.g. pick-up location) is made that much more challenging. Similar types of problems can be experienced when a passenger is being dropped off.

An additional issue arises with respect to passenger privacy. In many cases, a passenger is uncomfortable with revealing their residence or other locations closely associated with their personal use. Thus, these passenger may enter pick-up or drop off locations (e.g. vehicle stopping points) that are in a general vicinity of their actual desired location, but offset from that location so as to protect their privacy. Since the ride sharing application is operating on this intentionally incorrectly entered address information, selection of a pickup or drop off location can further degrade the user's experience. For example, a user may select a location that is several hundred yards or meters from their actual location or residence or end destination. If the ride sharing application then selects a pickup or drop off location further offset from the user's location, the user is required to walk or otherwise travel a further distance when using the ride sharing service.

The disclosed embodiments address these problems by implementing a machine learning model that selects a vehicle stopping point (e.g. a pick-up or drop off location) by considering the AV vehicle's location, the passenger's location, passenger preferences, and characteristics of a route between the selected pickup or drop off location and a second point. Generally, a vehicle stopping point, in at least some embodiments, is a stopping point of a vehicle where one or more passengers will enter the vehicle for travel, or exit the vehicle after travel. This is distinguished from other vehicle stopping points, such as stop signs or traffic lights at intersections. These stopping points are not within the definition of stopping points as used in this disclosure, except to the extent that a loading or unloading of passengers occurs at these locations.

The resulting solution provides for a reduced waiting time for passengers and thus an improved user experience. At least some of the disclosed embodiments further improve the user experience by considering passenger preferences when selecting a location. The passenger's privacy can be protected by automatically obscuring the passenger's residence or other personal address information when selecting a pick-up or drop off location, while still ensuring convenience and security to the passenger. This improved user experience contributes to a brand recognition of the ride sharing application and improves customer retention.

Some of the disclosed embodiments consider one or more of the following factors when selecting a pick-up, drop-off, or parking location: an initially selected location, an acceptable location as defined by the passenger, one or more characteristics of a vicinity of the initially selected location, including street directionality (bi-directional, one way in a first direction, one way in a second location, an amount of traffic, a direction of travel by a vehicle when approaching a location, visibility, frequency of unexpected events occurring within the proximity, restrictions within the proximity of the location (e.g. restricted parking, etc.), a walking or traveling speed of the passenger, a speed of the selected vehicle, a time of day the pick-up or drop off, or parking will occur.

Some embodiments maintain user preference information via a profile data structure that can be configured by the user via a ride sharing application. The user profile includes preference information such as a safety preference. The safety preference indicates the customer's preference for safer locations. Thus, when a higher safety preference is selected, the disclosed embodiments may weight a safety level of an area to, for example, a distance necessary to walk to arrive at a pick-up or drop off location. Some embodiments collect safety information on regions from governmental organizations or agency and/or via feedback provided by users of the ride hailing service. A time of day is also used in some embodiments to weight a user's safety preference. Thus, some embodiments reduce a regions safety score during nighttime hours for example. Some embodiments employ machine learning techniques to determine a regions safety and then determine a pick-up/drop off/parking location based on the determined. safety.

Some embodiments also consider last minute changes such as a user changing their preferences or real-world events such as traffic or accidents. Some embodiments subscribe to governmental alerts of road conditions to dynamically update routing information to ensure locations selected are consistent with the best known real-world environment at the time.

Some embodiments first select one or more candidate locations based on the local information such as that listed above. If the candidate locations do not sufficiently match the customer's selected location, candidate routes (e.g. walking routes) from the location selected by the passenger to the candidate locations are generated. Note that in some cases, multiple routes between the passengers selected location and a candidate location are generated. Some embodiments then score each of the generated routes. For example, some embodiments implement Equation 1 below:

Sᵢ=Pⁱd_{ν}ⁱ+exp(Fⁱmax{t_{c}ⁱ, t_{ν}ⁱ}) Eq. (1)

where:
Sᵢ the total score for a candidate route i,
d_{ν}ⁱ and t_{ν}ⁱ a distance (d) and estimated driving time (t) from a vehicle's current location to a candidate vehicle stopping point associated with route
p¹ a penalty rate factor that is based on a traffic status and a road situation,
t_{c}ⁱ an estimated travel time or duration between the candidate vehicle stopping point associated with route i and a second point, which can be either a passenger's starting location or ending location. When a candidate vehicle stopping point matches the passenger's location the passenger travel time t_{c}ⁱ is zero, and
Fⁱ is a safety factor for route i.

In some embodiments, t_{c}ⁱ and t_{ν}ⁱ are predicted via a machine learning algorithm. The machine learning algorithm is trained based on previous GPS tracking information and feedback from users on service ranking and detailed comments. With Equation 1 above, the score Sᵢ increases exponentially as a function of the passenger's total travel time (t_{c}ⁱ) and their waiting time (the difference of driver's driving time (t_{ν}ⁱ) and customer's travel time(t_{c}ⁱ). This approach emphasizes the importance of a passenger's safety.

Some embodiments consider portions of the routes e.g., route “segments) and assign different safety scores to each route segment. Such an approach considers, in at least some embodiments, one or more regions through which a particular route or route segment passes when scoring the route or route segment.

With a passenger pick-up scenario, some of these embodiments assume that a customer will wait for a vehicle at the candidate vehicle stopping point if they arrive before the vehicle. If a route i is divided into Kᵢ segments, some embodiments score a route i using Equation 2 below:

Sᵢ=Pⁱd_{ν}ⁱ+exp(F^{i,K}^{ᵢ}t_{c,wait}+Σₖ₌₁^{K}^{ᵢ} F^{i,k}t_{c}^{i,k}) Eq. (2)

where:
F^{i,k} a safety score of segment k of route i where k=1 . . . Kᵢ,
F^{i,K}^{ᵢ} a safety score of a last segment Kᵢ of route i,
t_{c}^{i,k} a passenger's travel time on segment k of route i,
t_{c}ⁱ is the total travel time on route i, and
t_{c,wait} a passengers waiting time after arrival at the candidate vehicle stopping point.

t_{c}ⁱ=Σₖ₌₁^{K}^{ᵢ} t_{c}^{i,k} Eq. (3)

where:
t_{c}ⁱ is the total walking time on route i, and
k number of segments on route i,
t_{c}^{i,k} walking time on segment k of route I,

$${t}_{c , wait} = \{ \begin{matrix}{t}_{v}^{i} - {t}_{c}^{i} , if {t}_{v}^{i} > {t}_{c}^{i} \\ 0 , else\end{matrix} \qquad Eq . ( 4 )$$

In some embodiments a route i having a lowest score Sᵢ is selected as a route to employ for a ride between the passenger and vehicle, with the vehicle stopping point (e.g., pick-up/drop-off location) associated with the route.

When determining a drop-off location, one or more candidate vehicle stopping points are generated in a similar manner as pick-up locations discussed above. If the generated candidate vehicle stopping points (e.g., drop-off locations) do not exactly match a location selected by the passenger, at least some of the disclosed embodiments generates routes (e.g. walking routes) from candidate drop off locations to a second point (e.g. the passenger's end destination). Some embodiments score these routes using Equation 5 below:

Sᵢ=Pⁱd_{ν}ⁱ+exp(Σₖ₌₁^{K}^{ᵢ} F^{i,k}t_{c}^{i,k}) Eq. (5)

Equation 5 uses definitions of Pⁱ, d_{ν}ⁱ, F^{i,k}, t_{c}^{i,k} and Kᵢ similar to those described above.

Moreover, some embodiments continuously or at least periodically reevaluate vehicle stopping points (e.g. pick-up/drop-off/parking locations) and their associated vehicle routes and second routes as the passenger and/or vehicle changes location and/or environmental conditions proximate to a selected vehicle stopping point evolve.

Some of the disclosed embodiments provide multiple candidate vehicle stopping points (e.g., pick-up/drop locations) having the best scores and then allow a user to select their preferred stopping point from the displayed choices. Some of these embodiments display, along with details of the vehicle stopping point itself, estimated travel times or durations (e.g. walking times) associated with the location.

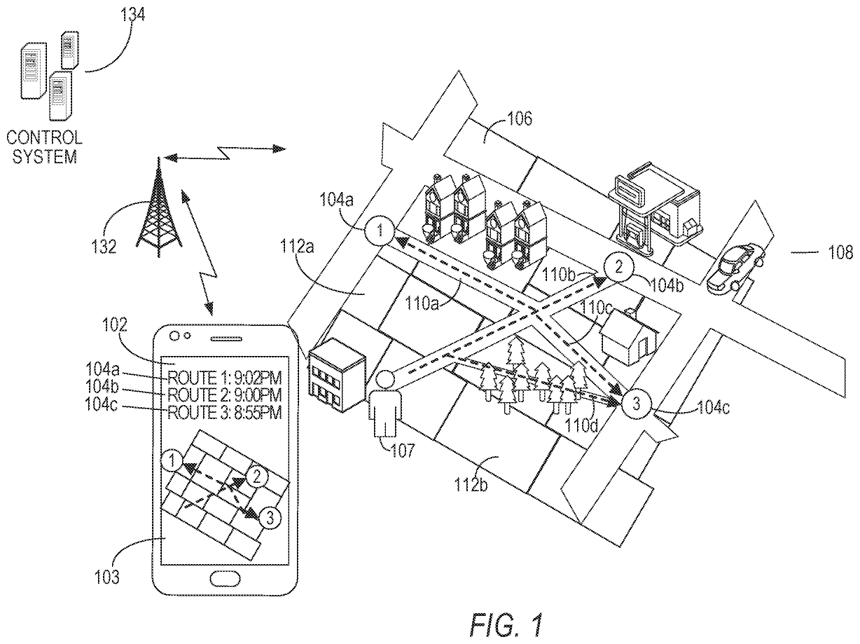

FIG. 1 is an overview diagram showing one embodiment of improving a user experience. The disclosed embodiments determine a vehicle stopping point e.g., pick-up and/or drop-off location) between a vehicle route and a second or secondary route of a passenger. Before a passenger is picked-up, the disclosed embodiments recognize that the passenger will need to travel to the pick-up location. In sonic cases, this entails the passenger walking or otherwise traveling to the pick-up location from their present location (e.g. via a second route). When dropping off a passenger, the disclosed embodiments recognize that after a passenger is dropped-off, the passenger will likely need to travel to their intended destination from the drop-off location (e.g. via a second route). Thus, associated with both a passenger pick-up and a passenger drop-off, is a vehicle route, and a second route for either traveling to the pick-up location, or traveling from the drop off location For a pick-up, the second route is traveled by the passenger before the pick-up occurs. For a drop-off, the second route is traveled by the passenger after the drop-off occurs. The disclosed embodiments determine vehicle stopping points that function as either a pick-up location or a drop-off locations. These embodiments also determine second routes associated with these vehicle stopping points, as discussed above.

This disclosure generally describes vehicle routes and secondary routes. When the disclosure references a route, this generally refers to a secondary route and not the route of the vehicle itself Although the vehicle route will also be adjusted when a vehicle stopping point is adjusted, the disclosed embodiments are generally directed to adjustments to the secondary route. The secondary route is generally not a vehicle route, in that it is different than the route of a vehicle carrying a passenger as discussed, for example, with respect to FIG. 1. In sonic cases, a passenger may ride a bike, skateboard, or other “vehicle” along a secondary route to a pick-up location (e.g. vehicle stopping point), and then board a vehicle, and travel along a vehicle route.

Alternatively, a passenger rides in a vehicle along a vehicle route, and then is dropped off at a vehicle stopping location. In some cases, the passenger travels along a secondary route away from the drop off location, and may either walk, or use a skateboard, bicycle, or other transportation device to travel along the secondary route. In some embodiments, the secondary route utilizes a different modality of transportation than the vehicle route (e.g. a bus or a train). In some cases, the secondary route utilizes a common modality as the vehicle route, but a physically different vehicle.

The example of FIG. 1 shows a pick-up operation, with the passenger traveling a secondary route before the pick-up occurs. FIG. 1 shows a mobile application 102 presenting a user interface 101 The user interface 103 displays a plurality of candidate pick-up locations. The plurality of candidate pick-up locations (e.g. vehicle stopping points) and their associated travel paths or secondary routes are labeled as location 104a, location 104b, and location 104c. FIG. 1 also shows a map 106 including three secondary routes for a passenger 107 to meet a vehicle 108. The travel paths or secondary routes are labeled as secondary route 110a, secondary route 110b, secondary route 110c, and secondary route 110d. The map 106 depicts a campus environment that does not allow public vehicles to enter. A similar situation arises when a passenger seeks to maintain privacy of their residence or other origin location and would prefer to be picked up proximate to, but not directly at, their origin location. Thus, as with at least some of the disclosed embodiments, the example of FIG. 1 contemplates two distinct routes, a first route traveled by the vehicle 108, and a secondary route traveled by the passenger 107 prior to being picked up by the vehicle.

Route 1104 represents a shorter route that passes through a grove of trees to location 104c while route 110c represents a longer route to location 104c that avoids the trees and travels along a populated walkway. Some embodiments partition a region represented by the map 106 into a plurality or regions. This partitioning of the area into regions is demonstrated via the rectangles, a portion of which are labeled as region 112a and region 112b. Not all regions are labeled to preserve figure clarity.

A shading of each region of FIG. 1 indicates a safety level associated with the region. Darker regions represent lower safety than lighter regions. As discussed above, some embodiments score each route or route segment based on a safety of a region through which the route or route segment passes. This score is further generated based on a vehicle's arrival time to a pick-up location associated with the route and a walking time of the passenger to the pick-up location (or drop off location).

In some embodiments, particular routes are eliminated based on user preference information. For example, in some embodiments, a user specifies a minimum safety level associated with any region through which they are asked to walk based on a pick-up or drop off location. If a particular route passes through a region that does not meet the passenger's profile preferences, that route is dropped from consideration. Some other embodiments consider a safety rating or score associated with a particular route (based on regions through which the route passes) along with a walking time and/or waiting time associated with the route. Thus, shorter, relatively less safe routes are selected, in some embodiments, over longer, somewhat more safe routes.

Sonic embodiments display a safety “heatmap” via a mobile application, and overlay the heat map with possible routes to a pick-up location. For drop-off scenarios, some embodiments display a heat map that is overlaid with routes to a preferred location from a variety of candidate drop-off locations.

FIG. 1 also illustrates that the mobile application 102 is in communication, via an communications network 132, with a mobility service 134. The mobility service 134 is configured, in at least some embodiments, to determine one or more possible pick-up or drop-off locations for the passenger 107 based on the passenger 107 preferences, and one or more characteristics of the routes 110a-d. The mobility service 134 then causes display of a set of one or more “best” or “optimal” pick-up/drop off locations and their associated routes.

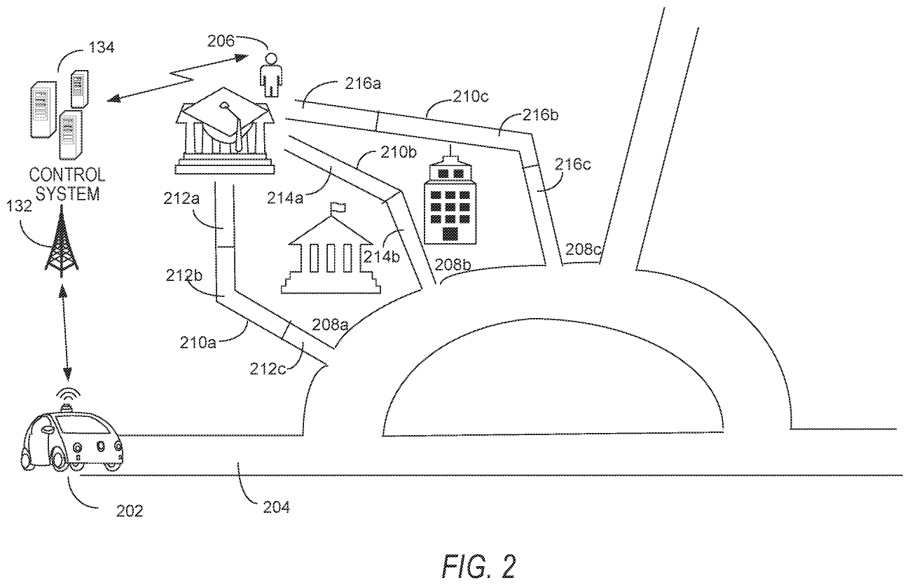

FIG. 2 is another overview diagram illustrating selection of a vehicle stopping point (e.g., pick-up or drop off location) for an autonomous vehicle based transportation service. FIG. 2 shows an AV 202 traveling along a road 204. The AV 202 is scheduled to pick up a passenger 206. The passenger 206 can meet the AV 202 at any one of three possible vehicle stopping points or pick-up locations, labeled location 208a, location 208b, and location 208c. To travel to each of the pick-up locations, the passenger would need to walk or otherwise travel a travel path from their illustrated location along one of the secondary routes, labeled route 210a, route 210b, and route 210c. Each of the secondary routes includes multiple segments. Secondary route 210a includes segment 212a, segment 212b, and segment 212c. Secondary route 210b includes segment 214a, and 214b. Secondary route 210c includes segment 216a, 216b, and 216c.

As discussed above, some embodiments score each of the secondary routes 210a-c based on scores of their individual respective segments. Thus, a score for secondary route 210a is based, in part, on scores of each of secondary route segments 212a-c. A score for secondary route 210b is based, in part, on scores of each of the secondary route segment 214a and 214b. A score for secondary route 210c is based, in part, on scores of each of the secondary route segments 216a, 216b, and 216c. Each of the secondary route segments 212a-c, 214a-b, and 216a-c also have, in some embodiments, individual safety scores, Each secondary route segment also has an associated distance and, in some embodiments, a parameter indicating a characteristic of the secondary route segment. For example, some embodiments store a characteristic indicating a typical walking speed on the segment. Some embodiments store a characteristic indicating whether the secondary route segment is concrete, asphalt, dirt, gravel, or other surface.

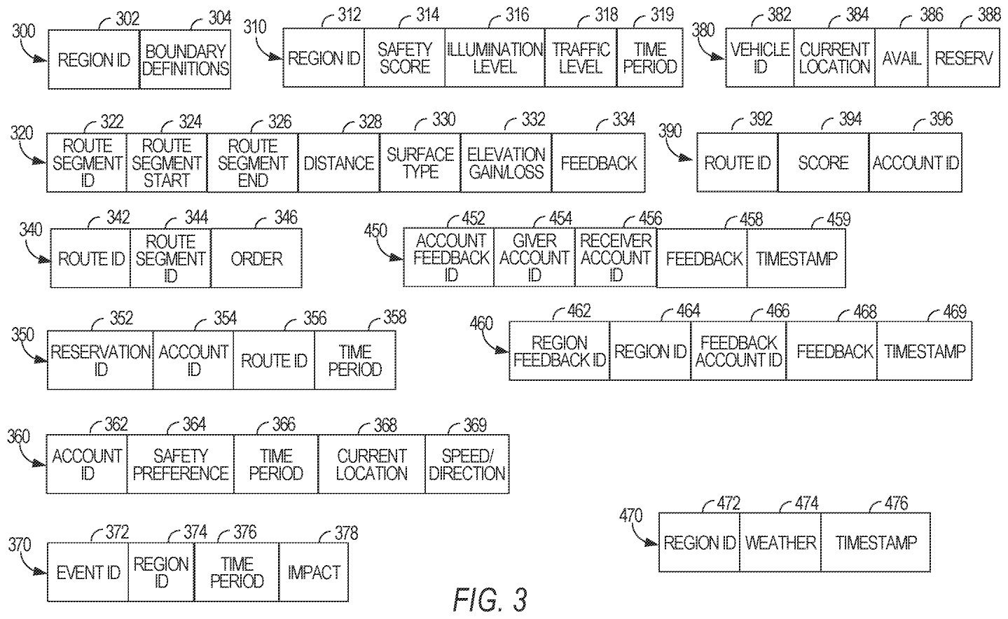

FIG. 3 shows example data structures implemented in one or more of the disclosed embodiments. While the data structures discussed below with respect to FIG. 3 are discussed as relational database tables, embodiments are not limited to that specific data architecture. Some embodiments utilize other data structure types, such as arrays, linked lists, unstructured data stores, or other data organization techniques.

FIG. 3 shows a region table 300, region characteristics table 310, route segment table 320, route table 340, reservations table 350, account table 360, event table 370, vehicle table 380, and a route score table 390.

The region table 300 includes a region identifier field 302 and boundary definitions field 304. The region identifier field 302 uniquely identifies a region. The boundary definitions field 304 defines boundaries for the region. For example, the boundary definitions field 304 defines coordinates of two corners in some embodiments implementing square regions. Some embodiments implementing rectangular regions define three corners of a region in the boundary definitions field 304.

The region characteristics table 310 includes a region identifier field 312, safety score field 314, illumination level field 316, a traffic level field 318, and a time period field 319. The region identifier field 312 uniquely identifies a particular region, and is cross referenceable with the region identifier field 302. The safety score field 314 defines a safety rating for the identified region. In some embodiments, the safety score indicated in the safety score field 314 is derived from government maintained crime statistics for the region. For example, some embodiments periodically query a web service provided by one or more organizations, such as governmental organizations or community organizations, that indicate crime levels within one or more regions. The information is then received from the web service. Some embodiments utilize such information to determine a safety score for a region, which is then indicated via the safety score field 314, In some embodiments, the safety score stored in the safety score field 314 is based on user feedback provided for the region or a route that passes through the region.

The illumination level field 316 represents a level of illumination available in the identified region. The traffic level field 318 represents an amount of traffic within the region. The time period field 319 identifies a time period when one or more of the safety score field 314, the illumination level field 316, and/or the traffic level field 318 are applicable. Some embodiments use one or more characteristics of a region, examples of which are provided in the example region characteristics table 310 are used to score the regions or routes traversing the regions so that a “best” or “optimal” route can be selected for a passenger/vehicle.

The route segment table 320 includes a route segment identifier field 322, route segment start field 324, route segment end field 326, a distance field 328, surface type field 330, an elevation gain/loss field 332, and a feedback score field 334. The route segment identifier field 322 uniquely identifies a route segment. The route segment start field 324 defines a starting position of the route segment. For example, in some embodiments, the route segment start field 324 defines coordinates of a start of the route segment. The route segment end field 326 defines an ending position of the route segment. For example, in sonic embodiments, the route segment end field 326 defines coordinates of an end of the route segment. The distance field 328 defines a distance covered by the route segment. The surface type field 330 defines a surface type associated with the route segment. For example, the surface type field 330 defines, in some embodiments, whether the route surface is concrete, asphalt, gravel, or dirt. The elevation gain/loss field 332 defines a number of feet or meters rise or fall when traveling from the start of the route to the end of the route. The feedback score field 334 indicates a feedback score for the route segment. The feedback score field 334 is determined, in some embodiments, based on feedback provided by users indicating their satisfaction with the route segment. In some embodiments, the feedback score indicated by the feedback score field 334 is further determined based on regional feedback, such as that indicated by the region feedback table 460, discussed below. One or more of the distance field 328, surface type field 330, elevation gain/loss field, 332, or feedback score field 334 are used, by various embodiments, when scoring a route including the route segment.

The route table 340 includes a route identifier field 342, a route segment identifier field 344, and an order field 346. The route identifier field 342. uniquely identifies a particular route. The route segment identifier field 344 identifies a route segment included in the route. In some embodiments, the route segment identifier field 344 is cross referenceable with the route segment identifier field 322. Multiple rows of the route table 340 define a route by linking those rows sharing a common value of the route identifier field 342. The order field 346 defines an order in which route segments are ordered to form the route.

The reservations table 350 includes a reservation identifier field 352, account identifier field 354, route identifier field 356, and a time period field 358. The reservation identifier field 352. uniquely identifies a reservation. The account identifier field 354 defines a user account associated with the reservation (see below discussion of account table 360). The route identifier field 356 defines a route assigned to the reservation. The time period field 358 defines a time period during which the reservation or trip associated with the reservation is performed.

The account table 360 includes an account identifier field 362, safety preference field 364, time period field 366, current location field 368, speed/direction field 369. The account identifier field 362 uniquely identifies a user account. The safety preference field 364 defines one or more preferences of a user associated with the account, and specifically with respect to safety. For example, the safety preference field 364 indicates, in some embodiments, a minimum safety level of any region through which the user must traverse when either traveling to a pick-up location or departing from a drop-off location. The time period field 366 indicates a time period during which the safety preference data is active. For example, some users specify minimum safety requirements only during non-business hours, while other users maintain safety minimums even during daylight hours. The current location field 368 indicates the user's current location, and the speed/direction field 369 indicates the user's current speed and/or direction. Various embodiments utilize one or more of the information defined in the safety preference field 364, time period field 366, current location field 368, and speed/direction field 369 when scoring routes and/or route segments for a user associated with the account.

The event table 370 includes an event identifier field 372, region identifier field. 374, and a time period 376. The event identifier field 372 uniquely identifies an event, the region identifier field 374 identifies a region affected by the event. The region identifier field 374 is cross referenceable, in some embodiments, with any of the other region identifier field discussed with respect to FIG. 3. The time period 376 indicates a time period during which the event is impacting the identified region. The impact field 378 indicates a nature of impact to the indicated region.

The vehicle table 380 includes a vehicle identifier field 382, current location field 384, availability field 386, and a reservation assignment field 388. The vehicle identifier field 382 uniquely identifies a vehicle. The current location field 384 defines a current location of the vehicle. The availability field 386 defines whether the vehicle is available or has been assigned a route. The reservation assignment field 388 indicates a reservation the vehicle has been assigned to complete.

The route score table 390 includes a route identifier field 392, score field 394. and account identifier field 396. The route identifier field 392 uniquely identifies a route, by cross referencing with the route identifier field 342 of the route table 340. The score field 394 defines a score of the route. For example, the score field 394 stores results of any one of Equations 1 or 2 discussed above. The account identifier field 396 defines an account associated with the route and score (e.g. the same route can have different scores depending on the account to which the route is assigned).

The account feedback table 450 includes an account feedback identifier field 452. a feedback giver account identifier field 454, feedback receiver account identifier field 456, a feedback field 458, and a timestamp field 459. The account feedback table 450 stores feedback on a particular account from another account. The account feedback identifier field 452 uniquely identifies individual feedback. The feedback giver account identifier field 454 identifies an account that provides the feedback and is cross referenceable with the account table 360, and specifically the account identifier field 362. The feedback receiver account identifier field 456 identifies an account receiving the feedback, and is cross referenceable with the account table 360, and specifically the account identifier field 362. The feedback field 458 stores the feedback received, In sonic embodiments, the feedback field 458 stores a value between zero and ten, with zero being poor feedback and ten (10) representing excellent feedback. Other embodiments use a different feedback scoring mechanism. The timestamp field 459 indicates a time associated with the feedback. In some embodiments, feedback on a particular account (e.g. feedback receiver account identifier field 456) is used in determining a route for the particular account.

The region feedback table 460 includes a region feedback identifier field 462, region identifier field 464, a feedback account identifier field 466, a feedback field 468, and a timestamp field 469.

The weather table 470 includes a region identifier field 472, weather field 474, and a timestamp field 476. The region identifier field 472 uniquely identifies a particular region, and is cross referenceable with the region identifier field 302. The weather field 474 indicates weather conditions within the region. For example, the weather field 474 indicates, in some embodiments, whether the region is experiencing rain, snow, sleet, cloudy conditions, fog, volcanic ash, winds, or other weather phenomena. The timestamp field 476 indicates a recency of the information stored in the weather field 474 (therefore indicating its likely relevance). In some embodiments, the weather table 470 is populated by periodically querying one or more external web services, in some cases maintained by a governmental entity.

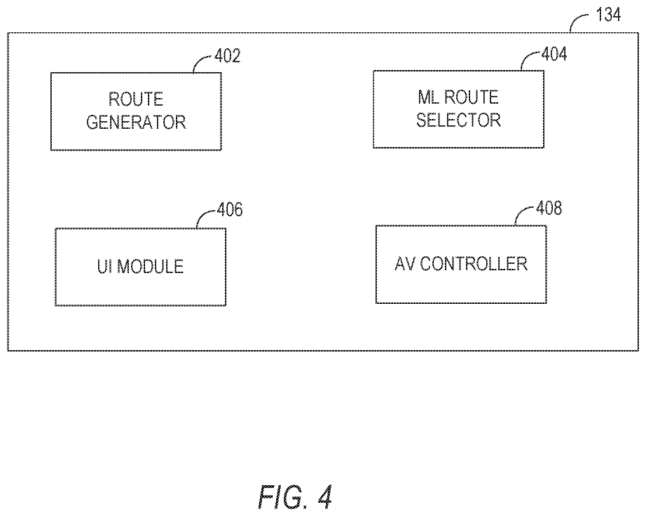

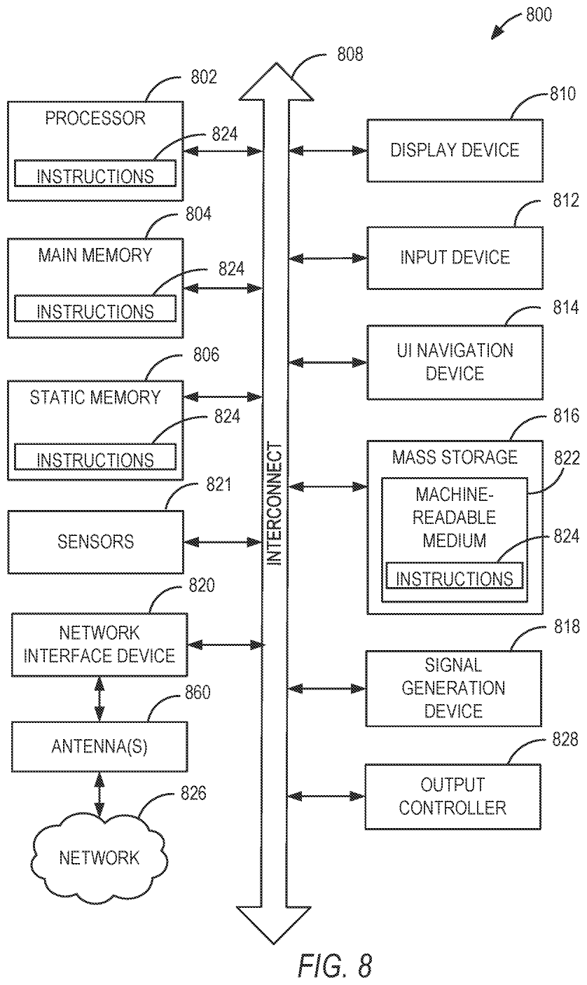

FIG. 4 is a block diagram of one embodiment of the mobility service 134, discussed above with respect to FIGS. 1 and 2. In some embodiments, the mobility service 134 implements or otherwise includes the machine 800, discussed below with respect to FIG. 8. The example mobility service 134 includes a route generator 402, machine learning (ML) route selector 404, a user interface (UI) module 406, and an AV controller 408. The route generator 402 generates one or more secondary routes for a passenger or user. The secondary route is between a vehicle stopping point and a second point In a pick-up scenario, the vehicle stopping point is the pick-up point, and is thus at an end of the secondary route. The second point represents an other end of the secondary route. In a drop-off scenario, the vehicle stopping point is a start of the secondary route, and a second point is at the other end of the secondary route

To generate secondary routes, the route generator 402 receives, as input a vehicle stopping point, and the second point The second point is generally associated with the user, and is, in some embodiments, a user's initial starting location when performing secondary route generation for a pick-up operation. The second point is the user's end destination when performing secondary route generation for a drop-off operation. The ML route selector 404 selects a secondary route from secondary routes generated by the route generator 402. As discussed above, the ML route selector 404 considers, in various embodiments, one or more user preferences when selecting a secondary route. In some embodiments, the Mt route selector 404 scores each of the secondary routes generated by the route generator 402 based on the user preferences, and further based on other characteristics of the secondary route, such as a safety associated with the secondary route or one or more segments of the secondary route, a distance associated with the secondary route, a walking surface associated with the secondary route, or other considerations.

The UI module 406 causes presentation of user interfaces on client devices and/or mobile applications interfacing with the mobility service 134. For example, the UI module 406 is configured to generate, in an example embodiment, the user interface 103 displayed by the mobile application 102 discussed above with respect to FIG. 1.

The AV controller 408 provides instructions to an AV consistent with a route selected by the ML route selector 404. For example, the AV controller 408 instructs an AV to proceed to a vehicle stopping point (e.g. pick-up or drop-off location) associated with a secondary route selected by the ML route selector 404.

Each of the components of FIG. 4, including the route generator 402, the ML route selector 404, UI module 406, and the AV controller 408 of FIG. 4 represent groupings of computer executable instructions that configure hardware processing circuitry to perform the functions discussed in this application and attributed to the particular component. Each of the groupings of executable instructions are stored, in some embodiments, in one or more memories (e.g. 804 and/or 806 discussed below)

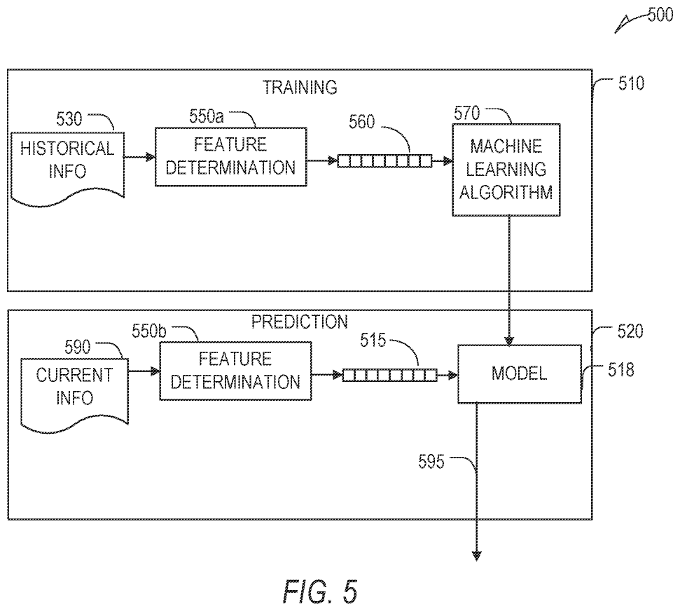

FIG. 5 shows an example machine learning module 500 according to some examples of the present disclosure. Machine learning module 500 utilizes a training module 510 and a prediction module 520. Training module 510 inputs historical information 530 into feature determination module 550a. The historical information 530 may be labeled. Example historical information may include user profile information discussed above. For example, one or more of user security preference and distance preference information is provided in some embodiments. Also provided as part of the historical information 530 is route information. For example, as discussed above, routes indicate a possible path taken between a vehicle stopping point and a second point (e.g. either to a pickup location or from a drop off location). This historical information is stored in a training library in some embodiments. Labels included in the training library indicate which secondary route is best given the particular user preference information.

Feature determination module 550a determines one or more features 560 from this historical information 530. Stated generally, features 560 are a set of the information input and are determined to be predictive of a particular outcome. In sonic examples, the features 560 may be all the historical information 530, but in other examples, the features 560 are a subset of the historical information 530. The machine learning algorithm 570 produces a model 518 based upon the features 560 and the labels.

In the prediction module 520, current information 590 may be input to the feature determination module 550b. The current information 590 in the disclosed embodiments include similar indications of that described above with respect to the historical information 530. However, the current information 590 provides these indications for a vehicle stopping point (e.g. user seeking a pick-up or drop off location). The current information 590 also includes possible secondary routes for the user to take when either traveling to the pick-up location or from a drop off location.

Feature determination module 550b determines, in some embodiments, an equivalent set of features or a different set of features from the current information 590 as feature determination module 550a determined from historical information 530. In some examples, feature determination module 550a and 550b are the same module. Feature determination module 550b produces features 515, which is input into the model 518 to generate a one or more routes and corresponding pick-up or drop off locations relating to those routes. The training module 510 may operate in an offline manner to train the model 518. The prediction module 520, however, may be designed to operate in an online manner. It should be noted that the model 518 may be periodically updated via additional training and/or user feedback.

The prediction module 520 generates one or more outputs 595. The outputs include, in some embodiments, one or more vehicle stopping points (e.g. pick-up/drop-off/parking locations) and routes between those vehicle stopping points (e.g., pick-up/drop-off/parking locations) and a second point. In some embodiments, predicted travel times or durations (e.g. walking times, roller skating times, scooter times, or bicycling times) associated with each of the pick-up/drop-off/parking locations are also provided by the ML model.

The machine learning algorithm 570 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAIR), and the like), random forests, linear classifiers, quadratic classifiers, k-nearest neighbor, linear regression, logistic regression, hidden Markov models, models based on artificial life, simulated annealing, and/or virology. Examples of unsupervised learning algorithms include expectation-maximization algorithms, vector quantization, and information bottleneck method. Unsupervised models may not have a training module 510. In an example embodiment, a regression model is used and the model 518 is a vector of coefficients corresponding to a learned importance for each of the features in the vector of features 560, 515. In some embodiments, to calculate a score, a dot product of the features 515 and the vector of coefficients of the model 518 is taken.

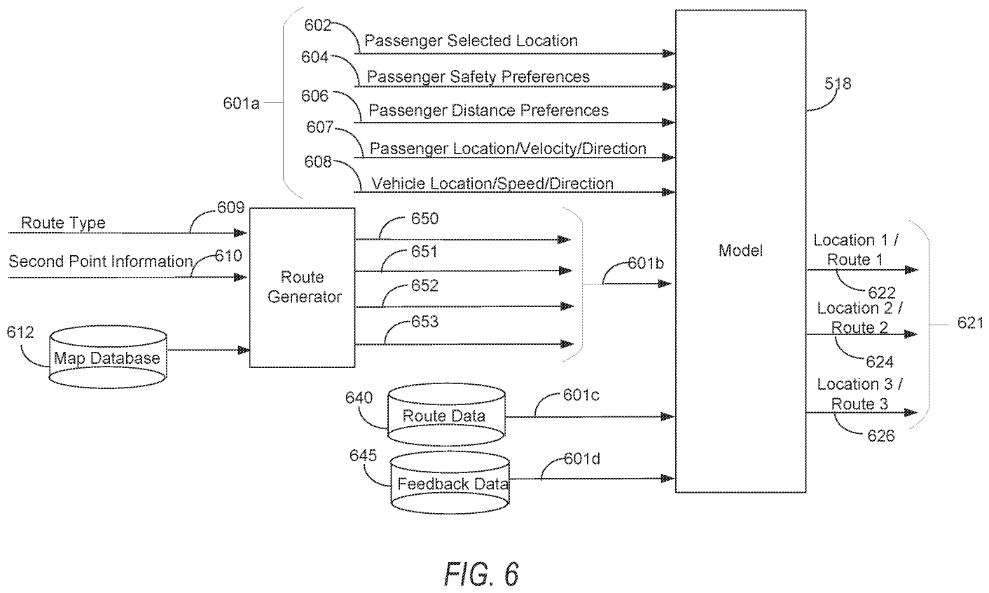

FIG. 6 shows data flow of a model in one or more of the disclosed embodiments. FIG. 6 shows one embodiment of a model, such as the model 518 of FIG. 5. The model 518 receives one or more of inputs 601a, 601b, 601c, or 601d and generates outputs 621. The input 601a includes information relating to a passenger and information relating to a vehicle. Based in part on the input 601a, the model 518 is trained to generate one or more highest scoring pick-up or drop-off locations for the passenger and the vehicle, and a route associated with the passenger before the pick-up or after the drop-off The input 601a includes one or more of a passenger selected location 602, passenger safety preference 604, passenger distance preference 606, passenger location, velocity, or direction 607, or a vehicle location, velocity, or direction 608. In some embodiments the passenger velocity or direction 607 and/or vehicle velocity or direction 608 are represented as a velocity vector within a vector space that includes the passenger, the vehicle, any relevant route segments and/or routes, regions, etc. The input 601a also includes vehicle information, such as one or more of a current vehicle location, speed, or direction 608.

FIG. 6 also shows the route generator 402, discussed above with respect to FIG. 4, receiving route type information 609 and second point information 610. The route type information 609 indicates whether the route is for a passenger pick-up, drop-off, or parking of an autonomous vehicle. The second point information 610 indicates, in some embodiments, a current passenger location. Alternatively, the second point is a destination location of the passenger. The second point information 610 represents one end of a secondary route generated by the route generator 402. The other end is a candidate vehicle stopping point. For example, if the route type indicates a passenger drop-off, the second point indicates where the passenger intends to travel after the drop off occurs. if the route type indicates a passenger pick-up, the second point indicates where the passenger is located, and thus a route is needed form the second point to any selected pick-up location.

The route generator 402 also receives map data from a map database 612, The map database stores information relating to possible routes. For example, in some embodiments, the map database 612 stores information analogous to the route table 340 and/or route segment table 320, and/or the region table 300, discussed above with respect to FIG. 3. Based on the second point information 610 (e.g. passenger location or passenger destination information), and the map database 612, the route generator 402 generates a plurality of possible secondary routes that facilitate the pick-up/drop-off/parking event identified by the route type information 609. This plurality of possible secondary routes is identified as route 650, route 651, route 652, and route 653. The plurality of possible secondary routes form input 601b, which is also provided to the model 518. FIG. 6 also shows route data 640 being provided to the model 518 as input 601c. The route data 640 includes, for example, characteristics of the secondary routes provided by the route generator 402. For example, in some embodiments, the route data 640 includes data analogous to the region characteristics table 310, discussed above with respect to FIG. 3. The route data 640 also includes, in some embodiments, data. analogous to that discussed above with respect to the event table 370. In some embodiments, the route data 640 also includes, data analogous to that discussed above with respect to the weather table 470. In some embodiments, the model 518 receives additional data not illustrated in FIG. 6.

Input 601d includes feedback from a feedback datastore 645 that is provided on users and/or regions or routes, For example, in some embodiments, a feedback data store includes data analogous to that of the account feedback table 450 and/or region feedback table 460, discussed above with respect to FIG. 3.

The model 518 is configured to generate, based on the inputs 601a, 601b, and 601c, one or more outputs 621. The outputs 621 obtained from the machine learning model include, in at least some embodiments, one or more suggested locations and corresponding routes for the passenger/vehicle combination indicated by the inputs. These suggested locations and routes are shown as suggestion 622, suggestion 624, and suggestion 626. In some embodiments, the model 518 is configured to generate estimated walking times for each of the suggested locations/routes. In some embodiments, the mobile application 102 displays the outputs 621 as the possible locations and their associated routes, such as location 104a, location 104b, and/or location 104c, for the passenger as illustrated above with respect to FIG. 1. Once a passenger selects one of the outputs, in some embodiments the AV controller 408 instructs an autonomous vehicle to travel to the selected location to perform the operation (e.g. pick-up, drop-off, or parking).

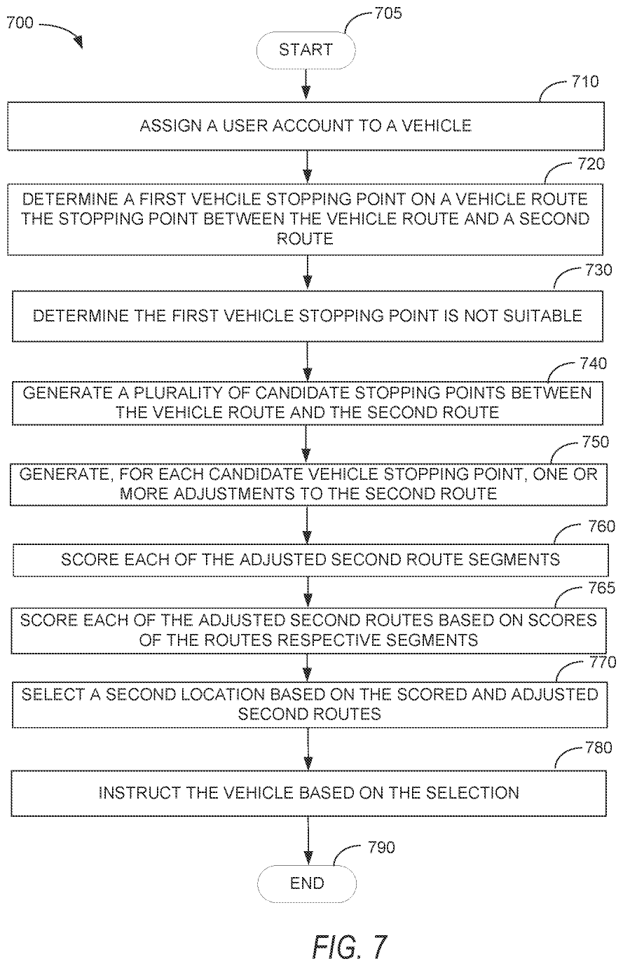

FIG. 7 is a flowchart of a method for determining a pick-up or drop off location of a passenger. In some embodiments, the method 700 discussed below with respect to FIG. 7 is used to determine a parking location for an autonomous vehicle, One or more of the functions discussed below with respect to FIG. 7 is performed via hardware processing circuitry. For example, in some embodiments, hardware processing circuitry (e.g. the hardware processor 802 discussed below) is configured by instructions (e.g. 824 discussed below) stored in a memory (e.g. memory 804 and/or 806 discussed below) to perform one or more of the functions discussed below with respect to FIG. 7 and/or method 700. In some embodiments, the mobility service 134, discussed above with respect to FIGS. 1 and/or 2, includes said hardware processing circuitry, instructions, and/or memory and performs the method 700.

After start operation 705, method 700 moves to operation 710, where a user account is assigned to a vehicle. For example, in some embodiments, assigning a user account to a vehicle includes establishing an association between the user account and the vehicle for a pick-up or drop-off operation, As one example, operation 710 includes, in sonic embodiments, updating a record for a vehicle (e.g. the vehicle table 380) to indicate the vehicle is assigned to a particular reservation (e.g. stored in the reservations table 350), with the reservation indicating a particular user account (e.g. via the account identifier field 354).

In operation 720, a first vehicle stopping point is assigned to a route of the vehicle. The first vehicle stopping point is a drop-off location in some embodiments. Alternatively, the first vehicle stopping point is a pick-up location in some other embodiments. The first vehicle stopping point is a parking location in still other embodiments. In some embodiments, operation 720 includes establishing an association between the vehicle and the first vehicle stopping point. For example, as discussed above with respect to FIG. 3, a reservation indicates, in some embodiments, a pick-up or drop-off or parking location via a route (e.g. indicated via route identifier field 356).

Method 700 contemplates two distinct routes. A first route is a route of the vehicle. A second route is a route between the first vehicle stopping point and a second point. The second route is not the vehicle route, In a passenger pick-up scenario, the first vehicle stopping point is near/proximate/within a predefined threshold distance of an end location of the second route, as the passenger travels the second route to arrive at the first vehicle stopping point before pick-up. In the passenger pick-up scenario, the second point is an origin location of the second route. This can be, in some circumstances, a starting location of the passenger before traveling to the vehicle stopping location (an end point of the second route in this case) to be picked up.

In a passenger drop off scenario, the first vehicle stopping point is near/proximate to/within a predefined threshold distance of a starting point of the second route, since the passenger uses the second route to travel to a destination after being dropped off by the vehicle. Thus, the second point in this scenario is an end location of the second route. Thus, the second route is bounded on one end by the vehicle stopping point, and on the other end by the second point.

In some embodiments, one or more of the vehicle's route and the second route include one or more route segments (e.g. indicated via route table 340, and one or more of the route segment identifier field 344). Each route segment includes a start and end location (e.g. via route segment start field 324 and route segment end field 326).

In operation 730, a determination is made that the first vehicle stopping point is not suitable. For example, in some embodiments, input from a passenger is received indicating a rejection of the first vehicle stopping point. In some embodiment, an external event occurs, (e.g. reflected in the event table 370 in example embodiments), which renders the first vehicle stopping point unsuitable. In some embodiments, operation 730 is performed by evaluating the first vehicle stopping point and the route assigned in operation 720 via a machine learning model (e.g. the model 518 discussed above). In some circumstances, a location/route, e.g. that is represented by the first vehicle stopping point and second route discussed above, is no longer suggested or recommended by the model (e.g. not present in the output 621 or not included in a highest ranked threshold number of locations/routes). In some cases, this is not necessarily due to any changes of conditions relating to the first vehicle stopping point and/or the second route itself. For example, conditions at a superior stopping point/route improve in some embodiments, thus rendering the first vehicle stopping point less suitable when compared to the improved conditions at another route/stopping point.

Some embodiments periodically or continuously re-evaluate or restore selected pick-up/drop-off/parking locations by re-invoking a machine learning model using updated or current input data (e.g. input represented by one or more of the example inputs 601a-c). In some embodiments, periodic updates on the user's location and/or vehicle location are received, and new candidate vehicle stopping points, vehicle routes and/or secondary routes are generated based on these updated locations.

An existing or newly generated vehicle stopping point and its associated vehicle route and second route are then compared to any new selections by the machine learning model. Some embodiments then modify the stopping point and associated vehicle route/second route based on a new selection by the machine learning model (e.g. if a score of the existing stopping point and associated routes differs from a new suggested stopping point and its associated routes by more than a threshold amount). Alternatively, the re-evaluation of a selected stopping point also results, in some circumstances, of a confirming of the selection of the stopping point based on rescored routes/locations.

In operation 740, a plurality of candidate vehicle stopping points are generated based on the unsuitability of the first vehicle stopping point. For example, as discussed above, in some embodiments, the route generator 402 generates a plurality of possible adjustments to the second route between the candidate second vehicle stopping point and a second point (start location or end location of the adjusted second route).

In operation 750, for each candidate vehicle stopping point, one or more adjustments to the second route are generated. The adjustments to the second route result in routes between the candidate vehicle stopping point and the second point. As discussed above, if the candidate vehicle stopping point is a drop off stopping point then adjustments to the route have the candidate vehicle stopping point as a starting point of the route, and an end point of the route is the second point, If the candidate vehicle stopping point is a pick-up location, the adjustments to the second route result in a route having the second point as a start of the adjusted second route, and the candidate vehicle stopping point as an end point to the adjusted second. route.

In operation 760, each of the segments of the adjusted second routes and the candidate vehicle stopping points are scored. For example, as discussed above, some embodiments score a route segment (e.g. a segment of an adjusted route) based, at least in part, on any of Equations 1 or 2. Some embodiments score a route or segments of a route based on one or more of Equations 1 or 2, a length of the route, crime statistics associated with the route or route segment, a relative safety level of one or more regions through which the route passes, an illumination level of the route (or of a region through which the route passes), a traffic level of the route (or a region through which the route passes), a walking surface of the route, or other factors. In some embodiments, the scoring of an adjusted second route (and its associated candidate vehicle stopping point or pick-up or drop off location) is further based on one or more characteristics of a road adjacent to the pick-up or drop off location (candidate vehicle stopping point). For example, a directionality of the road, level of traffic on the road, condition of the road, any active events that affect the road, contribute to scoring of the candidate vehicle stopping point (e.g. (pickup or drop-off location) and its adjusted second route

In some embodiments a safety level of a route or segments of a route is weighted in the scoring of the route or route segment based on a user's preference for safety stored in a user profile (e.g. indicated by safety preference field 364 in some example embodiments).

In some embodiments, the adjusted second routes and/or their segments are scored based on a modality of transportation used to travel the adjusted second route. For example, various embodiments employ buses, trains, skateboards, bicycles, roller skates, walking, or other transportation modalities to perform one or more of the adjusted second routes,

As discussed above, some embodiments provide historical preferences associated with the user account, and feedback information associated with the user account to the machine learning model, and score the routes or route segments based on these historical preferences and feedback information. Note that while method 700 describing adjusting second routes, an adjusting of the second route should generally not limit the modifications that are performed, in various embodiments to the original second route. Generally, an adjusted second route has two end points, one being the candidate vehicle stopping point, and the other being the second point.

In operation 765, each adjusted second route is scored based on the scores of its respective route segments. In some embodiments, the scores of the route segments are averaged to determine a score of the route. In some embodiments, the scores of the route segments are added to determine a score of the route. Other scoring methods are also contemplated, and the disclosed embodiments are not limited to these two examples (e.g. see Equations 1 and/or 2 above for example s of scoring a route i based on its respective segments). In some embodiments, route are scored based on a velocity vector of a mobile device associated with the user account, and or a velocity vector of the vehicle. In some embodiments, routes are scored based on a traffic level of a road or other event proximate to the candidate vehicle stopping point and/or directionality of a road proximate to the candidate vehicle stopping point.

In operation 770, a second vehicle stopping point is selected based on the scored routes (e.g. scored adjusted second routes). For example, in some embodiments, operation 770 selects a predefined number of highest scoring routes (with highest scoring routes being those deemed superior to a user (e.g. based on scoring of their respective route segments) and predicted to result in a highest level of satisfaction).

Some embodiments of operation 770 include presenting one or more of the highest scoring routes (e.g. highest scoring adjusted second routes) on a display device. The display device is associated with an account of the user (e.g. a smart phone or mobile phone of the user for example). In some embodiments, the mobility service 134 presents a web interface indicating the one or more routes/locations on a web browser of a client device (e.g. laptop, etc). In some embodiments, the mobility service 134 sends a message to a mobile application running on a mobile device, which causes the mobile application to display the one or more highest scoring routes and their associated pick-up location/drop-off location. In these embodiments, input is then received by the mobility service 134 indicating a user selection of one of the highest scoring routes/locations.

In operation 780, a vehicle is instructed to travel to the selected second vehicle stopping point. In some embodiments, the vehicle is also provided with a vehicle route from its present location to the selected second vehicle stopping point. In some embodiments, operation 780 is implemented via instructions stored in the AV controller 408, discussed above with respect to FIG. 4. lip some embodiments, operation 780 includes sending an electronic message to the vehicle indicating the selected second vehicle stopping point as a. destination. In sonic embodiments, the instructed vehicle is an autonomous vehicle, and therefore the instructions are transmitted to a control system of the autonomous vehicle.

After operation 780 completes, method 700 moves to end operation 790.

FIG. 8 illustrates a block diagram of an example machine 800 upon which any one or more of the techniques (e.g., methodologies) discussed herein may perform. Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink 808 (e.g., bus). In some embodiments, the example machine 800 is implemented by the mobility service 134.

Specific examples of main memory 804 include Random Access Memory (RAM), and semiconductor memory devices, which may include, in some embodiments, storage locations in semiconductors such as registers. Specific examples of static memory 806 include non-volatile memory, such as semiconductor memory devices (e.g., Electrically Programmable Read-Only Memory (EPROM). Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 800 may further include a display device 810, an input device 812 (e.g., a keyboard), and a user interface (UI) navigation device 814 (e.g., a mouse). In an example, the display device 810, input device 812 and navigation device 814 may be a touch screen display. The machine 800 may additionally include a mass storage device 816 (e.g., drive unit), a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NEC), etc.) connection to communicate or control one or more peripheral devices (e.g., a printer, card reader, etc.). in some embodiments the hardware processor 802 and/or instructions 824 may comprise processing circuitry and/or transceiver circuitry.

The mass storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the mass storage device 816 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 822 is illustrated as a single medium, the term “machine readable medium” may include a single medium or multiple media (e.g., a centralized or distributed database, and/or associated caches and servers) configured to store the one or more instructions 824.

An apparatus of the machine 800 may be one or more of a hardware processor 802 (e.g., a central processing unit (CPU), a graphics processing unit (GPU), a hardware processor core, or any combination thereof), a main memory 804 and a static memory 806, sensors 821, network interface device 820, antennas 860, a display device 810, an input device 812, a UI navigation device 814, a mass storage device 816, instructions 824, a signal generation device 818, and an output controller 828. The apparatus may be configured to perform one or more of the methods and/or operations disclosed herein. The apparatus may be intended as a component of the machine 800 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically. Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (MP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 820 may include one or more physical jacks (e.g., Ethernet, coaxial, or phone jacks) or one or more antennas to connect to the communications network 826. In an example, the network interface device 820 may include one or more antennas 860 to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques. The term “transmission medium” shall be taken to include any intangible medium that is capable of storing, encoding or carrying instructions for execution by the machine 800, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein, Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Example 1 is a method, comprising: generating a plurality of candidate vehicle stopping points between a route of a vehicle and a second route; generating, for each of the plurality of candidate vehicle stopping points, one or more adjustments to the second route, each of the adjusted second routes defining a travel path between the respective candidate vehicle stopping point and the second point, and each of the adjusted second routes comprising a plurality of segments; scoring each of the adjusted second route segments; scoring each of the adjusted second routes based on the scores of the segments of the adjusted second route; selecting a second vehicle stopping point from the plurality of candidate vehicle stopping points based on the scored adjusted second routes; and instructing the vehicle to proceed to the second vehicle stopping point.

In Example 2, the subject matter of Example 1 optionally includes assigning a user account to the vehicle, wherein the candidate vehicle stopping points are passenger drop off locations and the second point is an end destination of a passenger associated with the user account, or the candidate vehicle stopping points are passenger pick-up locations and the second point is an origin location of the passenger.

In Example 3, the subject matter of any one or more of Examples 1-2 optionally include wherein the scoring of the adjusted second routes is based on a modality of transportation of each of the adjusted second routes.

In Example 4, the subject matter of any one or more of Examples 1-3 optionally, include further comprising assigning a user account to the vehicle; and causing display, on a mobile device associated with the user account, a message indicating the second vehicle stopping point.

In Example 5, the subject matter of any one or more of Examples 1-4 optionally, include periodically receiving an updated user location and an updated vehicle location, and rescoring each of the adjusted second routes based on the updated user location and updated vehicle location, and confirming the selection of the second vehicle stopping point based on the rescored adjusted second routes.

In Example 6, the subject matter of any one or more of Examples 1-5 optionally, include wherein the selecting of the second vehicle stopping point is further based on a traffic level proximate to the second vehicle stopping point.

In Example 7, the subject matter of any one or more of Examples 1-6 optionally include assigning a user account to the vehicle, wherein the selecting of the second vehicle stopping point is further based on a velocity vector of a mobile device associated with the user account.

In Example 8, the subject matter of any one or more of Examples 1-7 optionally, include wherein the selecting of the second vehicle stopping point is further based on a directionality of a road proximate to the second vehicle stopping point.

In Example 9, the subject matter of any one or more of Examples 1-8 optionally include assigning a user account to the vehicle; and providing historical preferences associated with the user account, and feedback information associated with the user account to a machine learning model, wherein the assigning of the user account to the vehicle or the selecting of the second vehicle stopping point is based on an output of the machine learning model.

In Example 10, the subject matter of any one or more of Examples 1-9 optionally include wherein the selecting of the second vehicle stopping point is further based on a velocity vector of the vehicle.

In Example 11, the subject matter of any one or more of Examples 1-10 optionally include wherein the scoring of each of the adjusted second route segments is based on a distance or a travel time of each of the adjusted second route segments.

In Example 12, the subject matter of any one or more of Examples 1-11 optionally include wherein the scoring of each of the adjusted second routes is further based on a distance or a travel time of each of the adjusted second routes.

In Example 13, the subject matter of any one or more of Examples 1-12 optionally include wherein the selecting of the second vehicle stopping point is based on a time of day, or an illumination level at the second vehicle stopping point, a weather condition at the second vehicle stopping point, or an assigned safety level of the second vehicle stopping point.

In Example 14, the subject matter of Example 13 optionally includes assigning a user account to the vehicle, wherein the selecting of the second vehicle stopping point is further based on a safety preference associated with the user account.

In Example 15, the subject matter of any one or more of Examples 1-14 optionally include providing the adjusted second routes to a machine learning model, obtaining, from the machine learning model, a predicted travel time of each of the adjusted second routes, wherein the scoring of the adjusted second routes is based on the adjusted second routes respective predicted travel time.

In Example 16, the subject matter of any one or more of Examples 13-15 optionally include determining a predicted user waiting time with each of the adjusted second routes, and predicting a vehicle waiting time with each of the adjusted second routes, wherein the scoring of each of the adjusted second routes is based on the adjusted second routes respective user waiting time and vehicle waiting time.

In Example 17, the subject matter of any one or more of Examples 1-16 optionally include wherein the scoring of each of the segments is based on a safety score associated with the respective segment.

In Example 18, the subject matter of Example 17 optionally includes receiving crime statistics from a governmental agency, and determining the safety score based on the crime statistics.

In Example 19, the subject matter of Example 18 optionally includes receiving feedback from a passenger scoring an adjusted second route segment; and determining the safety score based on the feedback.

Example 20 is a system, comprising: hardware processing circuitry; and one or more hardware memories storing instructions that when executed configure the hardware processing circuitry to perform operations comprising: generating a plurality of candidate vehicle stopping points between a route of a vehicle and a second route; generating, for each of the plurality of candidate vehicle stopping points, one or more adjustments to the second route, each of the adjusted second routes defining a travel path between the respective candidate vehicle stopping point and the second point, and each of the adjusted second routes comprising a plurality of segments; scoring each of the adjusted second route segments; scoring each of the adjusted second routes based on the scores of the segments of the adjusted second route; selecting a second vehicle stopping point from the plurality of candidate vehicle stopping points based on the scored adjusted second routes; and instructing the vehicle to proceed to the second vehicle stopping point.

In Example 21, the subject matter of Example 20 optionally includes the operations further comprising assigning a user account to the vehicle, wherein the candidate vehicle stopping points are passenger drop off locations and the second point is an end destination of a passenger associated with the user account, or the candidate vehicle stopping points are passenger pick-up locations and the second point is an origin location of the passenger.

In Example 22, the subject matter of any one or more of Examples 20-21 optionally include wherein the scoring of the adjusted second routes is based on a modality of transportation of each of the adjusted second routes.

In Example 23, the subject matter of any one or more of Examples 20-22 optionally include the operations further comprising assigning a user account to the vehicle; and causing display, on a mobile device associated with the user account, a message indicating the second vehicle stopping point.

In Example 24, the subject matter of any one or more of Examples 20-23 optionally include the operations further comprising periodically receiving an updated user location and an updated vehicle location, and rescoring each of the adjusted second routes based on the updated user location and updated vehicle location, and confirming the selection of the second vehicle stopping point based on the rescored adjusted second routes.

In Example 25, the subject matter of any one or more of Examples 20-24 optionally include wherein the selecting of the second vehicle stopping point is further based on a traffic level proximate to the second vehicle stopping point.

In Example 26, the subject matter of any one or more of Examples 20-25 optionally include the operations further comprising assigning a user account to the vehicle, wherein the selecting of the second vehicle stopping point is further based on a velocity vector of a mobile device associated with the user account.

In Example 27, the subject matter of any one or more of Examples 20-26 optionally include wherein the selecting of the second vehicle stopping point is further based on a directionality of a road proximate to the second vehicle stopping point.

In Example 28, the subject matter of any one or more of Examples 20-27 optionally include the operations further comprising assigning a user account to the vehicle; and providing historical preferences associated with the user account, and feedback information associated with the user account to a machine learning model, wherein the assigning of the user account to the vehicle or the selecting of the second vehicle stopping point is based on an output of the machine learning model.

In Example 29, the subject matter of any one or more of Examples 20-28 optionally include wherein the selecting of the second vehicle stopping point is further based on a velocity vector of the vehicle.

In Example 30, the subject matter of any one or more of Examples 20-29 optionally include wherein the scoring of each of the adjusted second route segments is based on a distance or a travel time of each of the adjusted second route segments.

In Example 31, the subject matter of any one or more of Examples 20-30 optionally include wherein the scoring of each of the adjusted second routes is further based on a distance or a travel time of each of the adjusted second routes.

In Example 32, the subject matter of any one or more of Examples 20-31 optionally include wherein the selecting of the second vehicle stopping point is based on a time of day, or an illumination level at the second vehicle stopping point, a weather condition at the second vehicle stopping point, or an assigned safety level of the second vehicle stopping point.

In Example 33, the subject matter of Example 32 optionally includes the operations further comprising assigning a user account to the vehicle, wherein the selecting of the second vehicle stopping point is further based on a safety preference associated with the user account.

In Example 34, the subject matter of any one or more of Examples 20-33 optionally include the operations further comprising providing the adjusted second routes to a machine learning model, obtaining, from the machine learning model, a predicted travel time of each of the adjusted second routes, wherein the scoring of the adjusted. second routes is based on the adjusted second routes respective predicted travel time.

In Example 35, the subject matter of any one or more of Examples 32-34 optionally include the operations further comprising determining a predicted user waiting time with each of the adjusted second routes, and predicting a vehicle waiting time with each of the adjusted second routes, wherein the scoring of each of the adjusted second routes is based on the adjusted second routes respective user waiting time and vehicle waiting time.

Incorrect Numbering: 36

In Example 36, the subject matter of any one or more of Examples 20-35 optionally include wherein the scoring of each of the segments is based on a safety score associated with the respective segment.

In Example 37, the subject matter of Example 36 optionally includes the operations further comprising receiving crime statistics from a governmental agency, and determining the safety score based on the crime statistics.

In Example 38, the subject matter of Example 37 optionally includes the operations further comprising receiving feedback from a passenger scoring an adjusted second route segment; and determining the safety score based on the feedback.

Example 39 is at least one non-transitory computer readable storage medium comprising instructions that when executed by at least one hardware processor, configure the at least one hardware processor to perform operations comprising: generating a plurality of candidate vehicle stopping points between a route of a vehicle and a second route ; generating, for each of the plurality of candidate vehicle stopping points, one or more adjustments to the second route, each of the adjusted second routes defining a travel path between the respective candidate vehicle stopping point and the second point, and each of the adjusted second routes comprising a plurality of segments; scoring each of the adjusted second route segments; scoring each of the adjusted second routes based on the scores of the segments of the adjusted second route; selecting a second vehicle stopping point from the plurality of candidate vehicle stopping points based on the scored adjusted second routes; and instructing the vehicle to proceed to the second vehicle stopping point.

In Example 40, the subject matter of Example 39 optionally includes the operations further comprising assigning a user account to the vehicle, wherein the candidate vehicle stopping points are passenger drop off locations and the second point is an end destination of a passenger associated with the user account, or the candidate vehicle stopping points are passenger pick-up locations and the second point is an origin location of the passenger.

In Example 41, the subject matter of any one or more of Examples 39-40 optionally include wherein the scoring of the adjusted second routes is based on a modality of transportation of each of the adjusted second routes.

In Example 42, the subject matter of any one or more of Examples 39-41 optionally include the operations further comprising assigning a user account to the vehicle; and causing display, on a mobile device associated with the user account, a message indicating the second vehicle stopping point.

In Example 43, the subject matter of any one or more of Examples 39-42 optionally include the operations further comprising periodically receiving an updated user location and an updated vehicle location, and rescoring each of the adjusted second routes based on the updated user location and updated vehicle location, and confirming the selection of the second vehicle stopping point based on the rescored adjusted second routes.

In Example 44, the subject matter of any one or more of Examples 39-43 optionally include wherein the selecting of the second vehicle stopping point is further based on a traffic level proximate to the second vehicle stopping point.

In Example 45, the subject matter of any one or more of Examples 39-44 optionally include the operations further comprising assigning a user account, to the vehicle, wherein the selecting of the second vehicle stopping point is further based on a velocity vector of a mobile device associated with the user account.

In Example 46, the subject matter of any one or more of Examples 39-45 optionally include wherein the selecting of the second vehicle stopping point is further based on a directionality of a road proximate to the second vehicle stopping point.

In Example 47, the subject matter of any one or more of Examples 39-46 optionally include the operations further comprising assigning a user account to the vehicle and providing historical preferences associated with the user account, and feedback information associated with the user account to a machine learning model, wherein the assigning of the user account to the vehicle or the selecting of the second vehicle stopping point is based on an output of the machine learning model.

In Example 48, the subject matter of any one or more of Examples 39-47 optionally include wherein the selecting of the second vehicle stopping point is further based on a velocity vector of the vehicle.

In Example 49, the subject matter of any one or more of Examples 39-48 optionally include wherein the scoring of each of the adjusted second route segments is based on a distance or a travel time of each of the adjusted second route segments.

In Example 50, the subject matter of any one or more of Examples 39-49 optionally include wherein the scoring of each of the adjusted second routes is further based on a distance or a travel time of each of the adjusted second routes.

In Example 51, the subject matter of any one or more of Examples 39-50 optionally include wherein the selecting of the second vehicle stopping point is based on a time of day, or an illumination level at the second vehicle stopping point, a weather condition at the second vehicle stopping point, or an assigned safety level of the second vehicle stopping point.

In Example 52, the subject matter of Example 51 optionally includes the operations further comprising assigning a user account to the vehicle, wherein the selecting of the second vehicle stopping point is further based on a safety preference associated with the user account. In Example 53, the subject matter of any one or more of Examples 39-52 optionally include the operations further comprising providing the adjusted second routes to a machine learning model, obtaining, from the machine learning model, a predicted travel time of each of the adjusted second routes, wherein the scoring of the adjusted second routes is based on the adjusted second routes respective predicted travel time.

In Example 54, the subject matter of Example 53 optionally includes the operations further comprising assigning a user account to the vehicle, determining a predicted user waiting time with each of the adjusted second routes, and predicting a vehicle waiting time with each of the adjusted second routes, wherein the scoring of each of the adjusted second routes is based on the adjusted second routes respective user waiting time and vehicle waiting time.

In Example 55, the subject matter of any one or more of Examples 39-54 optionally include wherein the scoring of each of the segments is based on a safety score associated with the respective segment.

In Example 56, the subject matter of Example 55 optionally includes the operations further comprising receiving crime statistics from a governmental agency, and determining the safety score based on the crime statistics.

In Example 57, the subject matter of Example 56 optionally includes the operations further comprising receiving feedback from a passenger scoring an adjusted second route segment; and determining the safety score based on the feedback.

Example 58 is an apparatus, comprising: means for generating a plurality of candidate vehicle stopping points between a route of a vehicle and a second route ; means for generating, for each of the plurality of candidate vehicle stopping points, one or more adjustments to the second route, each of the adjusted second routes defining a travel path between the respective candidate vehicle stopping point and the second point, and each of the adjusted second routes comprising a plurality of segments; means for scoring each of the adjusted second route segments; means for scoring each of the adjusted second routes based on the scores of the segments of the adjusted second route; means for selecting a second vehicle stopping point from the plurality of candidate vehicle stopping points based on the scored adjusted second routes; and means for instructing the vehicle to proceed to the second vehicle stopping point.

In Example 59, the subject matter of Example 58 optionally includes means for assigning a user account to the vehicle, wherein the candidate vehicle stopping points are passenger drop off locations and the second point is an end destination of a passenger associated with the user account, or the candidate vehicle stopping points are passenger pick-up locations and the second point is an origin location of the passenger.

In Example 60, the subject matter of any one or more of Examples 58-59 optionally include wherein the means for scoring the adjusted second routes is configured to base the score of an adjusted route on a modality of transportation of the adjusted second routes.

In Example 61, the subject matter of any one or more of Examples 58-60 optionally include means for assigning a user account to the vehicle, and means for causing display, on a mobile device associated with the user account, a message indicating the second vehicle stopping point,

In Example 62, the subject matter of any one or more of Examples 58-61 optionally include means for periodically receiving an updated user location and an updated vehicle location, and means for rescoring each of the adjusted second routes based on the updated user location and updated vehicle location, and means for confirming the selection of the second vehicle stopping point based on the rescored adjusted second routes.

In Example 63, the subject matter of any one or more of Examples 58-62 optionally include wherein the means for selecting of the second vehicle stopping point is configured to select the second vehicle stopping point further based on a traffic level proximate to the second vehicle stopping point.

In Example 64, the subject matter of any one or more of Examples 58-63 optionally include means for assigning a user account to the vehicle, wherein the means for selecting of the second vehicle stopping point is configured to select the second vehicle stopping point further based on a velocity vector of a mobile device associated with the user account.

In Example 65, the subject matter of any one or more of Examples 58-64 optionally include wherein the means for selecting of the second vehicle stopping point is configured to further select the second vehicle stopping point based on a directionality of a road proximate to the second vehicle stopping point.

In Example 66, the subject matter of any one or more of Examples 58-65 optionally include means for assigning a user account to the vehicle, and means for providing historical preferences associated with the user account, and feedback information associated with the user account to a machine learning model, wherein the means for assigning of the user account to the vehicle or the means for selecting of the second vehicle stopping point are configured to assign the user account or select the second vehicle stopping point based on an output of the machine learning model.

In Example 67, the subject matter of any one or more of Examples 58-66 optionally include wherein the means for selecting of the second vehicle stopping point is configured to select the second vehicle stopping point further based on a velocity vector of the vehicle. In Example 68, the subject matter of any one or more of Examples 58-67 optionally include wherein the means for scoring of each of the adjusted second route segments is configured to score each of the adjusted second route segments based on a distance or a travel time of each of the adjusted second route segments.

In Example 69, the subject matter of any one or more of Examples 58-68 optionally include wherein the means for scoring of each of the adjusted second routes is configured to score each of the adjusted second route segments further based on a distance or a travel time of each of the adjusted second routes.

In Example 70, the subject matter of any one or more of Examples 58-69 optionally include wherein the means for selecting of the second vehicle stopping point is configured to base the selection on a time of day, or an illumination level at the second vehicle stopping point, a weather condition at the second vehicle stopping point, or an assigned safety level of the second vehicle stopping point.

In Example 71, the subject matter of Example 70 optionally includes means for assigning a user account to the vehicle, wherein the means for selecting of the second vehicle stopping point is configured to select the second vehicle stopping point further based on a safety preference associated with the user account.

In Example 72, the subject matter of any one or more of Examples 58-71 optionally include means for providing the adjusted second routes to a machine learning model, and means for obtaining, from the machine learning model, a predicted travel time of each of the adjusted second routes, wherein the means for scoring of the adjusted second routes is configured to score each of the adjusted second routes based on the adjusted second routes respective predicted travel time.

In Example 73, the subject matter of any one or more of Examples 70-72 optionally include means for determining a predicted user waiting time with each of the adjusted second routes, and means for predicting a vehicle waiting time with each of the adjusted second routes, wherein the means for scoring of each of the adjusted second routes is configured to score an adjusted second route based on the adjusted second routes respective user waiting time and vehicle waiting time.

In Example 74, the subject matter of any one or more of Examples 58-73 optionally include wherein the means for scoring of each of the segments is configured to score each of the segments based on a safety score associated with the respective segment.

In Example 75, the subject matter of Example 74 optionally includes means for receiving crime statistics from a governmental agency, and means for determining the safety score based on the crime statistics.

In Example 76, the subject matter of Example 75 optionally includes means for receiving feedback from a passenger scoring an adjusted second route segment; and means for determining the safety score based on the feedback.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

What is claimed is:

1. A system, comprising:
hardware processing circuitry;
one or more hardware memories storing instructions that when executed configure the hardware processing circuitry to perform operations comprising:
generating a plurality of candidate vehicle stopping points between a route of a vehicle and a second route;
generating, for each of the plurality of candidate vehicle stopping points, one or more adjustments to the second route, each of the adjusted second routes defining a travel path between the respective candidate vehicle stopping point and a second point, and each of the adjusted second routes comprising a plurality of segments;
scoring each of the adjusted second route segments;
scoring each of the adjusted second routes based on the scores of the segments of the adjusted second route;
selecting a second vehicle stopping point from the plurality of candidate vehicle stopping points based on the scored adjusted second routes; and
instructing the vehicle to proceed to the second vehicle stopping point.

2. The system of claim 1, the operations further comprising assigning the vehicle to a user account, wherein the candidate vehicle stopping points are passenger drop off locations and the second point is an end destination of a passenger associated with the user account, or wherein the candidate vehicle stopping points are passenger pick-up locations and the second point is an origin location of the passenger associated with the user account.

3. The system of claim 1, wherein the scoring of the adjusted second routes is based on a modality of transportation of each of the adjusted second routes.

4. The system of claim 1, the operations further comprising assigning a user account to the vehicle; and causing display, on a mobile device associated with the user account, a message indicating the second vehicle stopping point.

5. The system of claim 1, the operations further comprising periodically receiving an updated user location and an updated vehicle location, and rescoring each of the adjusted second routes based on the updated user location and updated vehicle location, and confirming the selection of the second vehicle stopping point based on the rescored adjusted second routes.

6. The system of claim 1, the operations further comprising assigning a user account to the vehicle; and providing historical preferences associated with the user account and feedback information associated with the user account to a machine learning model, wherein the assigning of the user account to the vehicle or the selecting of the second vehicle stopping point is based on an output of the machine learning model.

7. The system of claim 1, wherein the selecting of the second vehicle stopping point is based on: a time of day, an illumination level at the second vehicle stopping point, a weather condition at the second vehicle stopping point, or an assigned safety level of the second vehicle stopping point.

8. The system of claim 7, the operations further comprising assigning a user account to the vehicle, wherein the selecting of the second vehicle stopping point is further based on a safety preference associated with the user account.

9. The system of claim 1, the operations further comprising:
providing the adjusted second routes to a machine learning model; and
obtaining, from the machine learning model, a predicted travel time of each of the adjusted second routes, wherein the scoring of the adjusted second routes is based on the adjusted second routes respective predicted travel time.

10. The system of claim 7, the operations further comprising:
determining a predicted user waiting time with each of the adjusted second routes; and
predicting a vehicle waiting time with each of the adjusted second routes, wherein the scoring of each of the adjusted second routes is based on the adjusted second routes respective user waiting time and vehicle waiting time.

11. The system of claim 1, wherein the scoring of each of the segments is based on a safety score associated with the respective segment.

12. The system of claim 11, the operations further comprising receiving feedback from a passenger scoring an adjusted second route segment; and determining the safety score based on the feedback.

13. At least one non-transitory computer readable medium comprising instructions that, when executed by at least one processor, configure the at least one processor to perform operations comprising:
generating a plurality of candidate vehicle stopping points between a route of a vehicle and a second route;
generating, for each of the plurality of candidate vehicle stopping points, one or more adjustments to the second route, each of the adjusted second routes defining a travel path between the respective candidate vehicle stopping point and a second point, each of the adjusted second routes comprising a plurality of segments;
scoring each of the adjusted second route segments;
scoring each of the adjusted second routes based on the scores of the segments of the adjusted second route;
selecting a second vehicle stopping point from the plurality of candidate vehicle stopping points based on the scored adjusted second routes; and
instructing the vehicle to proceed to the second vehicle stopping point.

14. The at least one non-transitory computer readable medium of claim 13, further comprising assigning a user account to the vehicle, wherein the candidate vehicle stopping points are passenger drop off locations and the second point is an end destination of a passenger associated with the user account, or wherein the candidate vehicle stopping points are passenger pick-up locations and the second point is an origin location of the passenger.

15. The at least one non-transitory computer readable medium of claim 13, the operations further comprising periodically receiving an updated user location and an updated vehicle location, and rescoring each of the adjusted second routes based on the updated user location and updated vehicle location, and confirming the selection of the second vehicle stopping point based on the rescored adjusted second routes.

16. The at least one non-transitory computer readable medium of claim 13, wherein the selecting of the second vehicle stopping point is further based on a traffic level proximate to the second vehicle stopping point.

17. The at least one non-transitory computer readable medium of claim 13, the operations further comprising assigning a user account to the vehicle, wherein the selecting of the second vehicle stopping point is further based on a velocity vector of a mobile device associated with the user account.

18. The at least one non-transitory computer readable medium of claim 13, wherein the selecting of the second vehicle stopping point is further based on a directionality of a road proximate to the second vehicle stopping point.

19. An apparatus, comprising:
means for generating a plurality of candidate vehicle stopping points between a route of a vehicle and a second route:
means for generating, for each of the plurality of candidate vehicle stopping points, one or more adjustments to the second route, each of the adjusted second routes defining a travel path between the respective candidate vehicle stopping point and a second point, each of the adjusted second routes comprising a plurality of segments;
means for scoring each of the adjusted second route segments;
means for scoring each of the adjusted second routes based on the scores of the segments of the adjusted second route;
means for selecting a second vehicle stopping point from the plurality of candidate vehicle stopping points based on the scored adjusted second routes; and
means for instructing the vehicle to proceed to the second vehicle stopping point.

20. The apparatus of claim 19, further comprising means for periodically receiving an updated user location and an updated vehicle location, and means for rescoring each of the adjusted second routes based on the updated user location and updated vehicle location; and means for confirming the selection of the second vehicle stopping point based on the rescored adjusted second routes.
